(19) United States
(12) Patent Application Publication
(10) Pub. No.: US 2025/0206447 A1
(43) Pub. Date: Jun. 26, 2025

(54) HYBRID AIRCRAFT USING WAVE ENGINE AND ELECTRIC PROPULSION

(71) Applicant: North American Wave Engine Corporation, Baltimore, MD (US)

(72) Inventor: Daanish MAQBOOL, North Bethesda, MD (US)

(21) Appl. No.: 19/001,099

(22) Filed: Dec. 24, 2024

Related U.S. Application Data
(60) Provisional application No. 63/614,749, filed on Dec. 26, 2023.

(51) Int. Cl. B64D 27/02; B64C 11/28; B64D 27/357; B64D 33/02

(52) U.S. Cl. CPC B64D 27/026; B64C 11/28; B64D 27/357; B64D 33/02

(57) ABSTRACT

A hybrid aircraft architecture is disclosed that uses an electric motor-generator-propeller propulsion system for takeoff, landings, and low speed flying, and wave engines for cruise-condition flying and flying at high speeds. The propeller of the electric motor-generator-propeller propulsion system can be located at the nose or aft end (tail) of the aircraft. The wave engines can be located at the aft end of the fuselage, or under or integrated into the wing structures. The wave engines can be deployed in pairs and the wave engines of the pair may be cross-connected and operated in an anti-phase mode to reduce the noise and vibration that would exist if each wave engine is operated independently.

### CROSS-REFERENCES TO RELATED APPLICATIONS

This application claims the benefit of priority to U.S. Provisional Application Ser. No. 63/614,749, filed Dec. 26, 2023, the disclosure of which is incorporated by reference in its entirety.

### FIELD OF THE INVENTION

The present disclosure relates to aircraft generally, and propulsion systems for aircraft that include, but is not limited to, pulsejet, electric, and hybrid propulsion systems. More specifically, the present disclosure relates to pulse combustors, pulsejet engines, and electric motor propulsion that may be elements for propulsion of aircraft.

### BACKGROUND OF THE INVENTION

Conventional aircraft are typically powered by a single type of propulsion system (engine) even though a single aircraft may have multiples of these types of engines. For example, a single aircraft may have more than one piston engine, gas turbine (jet) engine, or electric motor as its propulsion source. Of these different types of propulsion systems, piston and gas turbine engines enable aircraft to travel long ranges because of the high energy density and specific energy of aviation fuels. However, electric-powered aircraft are range-limited due to the relatively low energy density and specific energy of state-of-the-art batteries or other electric storage systems. Further, gas turbine (jet) engines are typically capable of powering aircraft to much higher speeds than piston engines and electric motors. While gas turbine engines perform well in terms of speed and range, they are expensive and complicated systems, and difficult to maintain or scale down in size while maintaining operating practicality. Piston engines are inexpensive but also require considerable maintenance. Electric motors and batteries offer simple operation with little maintenance, but the performance of electric powertrains is limited by the limited energy characteristics of batteries.

As stated, typically, an aircraft will use one type of propulsion system; however, in some cases, it has been found advantageous to combine multiple types of propulsion systems. For example, some aircraft combine electric motors for VTOL (vertical takeoff and landing) and a piston engine for forward (cruise) flight. This propulsion configuration permits aircraft to leverage the convenience, high level of control, and mechanical simplicity of electric propulsion for distributed lift, and the superior energy and range that the piston engine provides by burning aviation fuel or its equivalent for long range flight. However, hybrid architectures such as this remain limited by the speed and maintenance associated with piston engines, and also limited by the often high drag imposed by the vertical lift electric motor and propeller structures/assemblies.

Noting the foregoing, it would be advantageous to have a hybrid propulsion system for aircraft that would require limited maintenance, enable the aircraft to achieve high speeds, reduce ground level noise for takeoffs and landings, have a long travel range, and enable short field takeoffs.

### SUMMARY OF THE INVENTION

The present invention relates to hybrid propulsion systems for use with aircraft. Regarding a hybrid-type of aircraft, it has multiple propulsion systems, such as an electric motor-generator that has a variable-pitch propeller and a wave engine, i.e., a pulsejet engine. For conventional (horizontal) takeoff, landing, and low speed flight, the aircraft may be primarily propelled by the electric motor-generator and propeller. For high speed and cruising flight, the aircraft may be propelled by the pulsejet engine. For short runway takeoff, the two types of propulsion systems can be used together to achieve takeoff velocity much more rapidly. The aircraft can also employ the use of the wave engines in pairs to reduce noise and vibrations that can be caused by wave engines. When an aircraft is being propelled by the pulsejet engine(s), the propeller may be feathered, locked, or folded to minimize drag. Alternatively, the propeller may be windmilled for turning the motor-generator to generate electrical power for the aircraft. Further, a scoop maybe positioned along the aircraft fuselage for channeling forced air to the motor-generator for turning the generator during times the aircraft is propelled by the wave engine(s). Generally, a scoop may be an inlet disposed along any outer surface of the aircraft fuselage that protrudes into the space immediately surrounding the aircraft that captures air as the aircraft is in motion.

Disclosed herein is a hybrid propelled aircraft including a fuselage having a nose end and an aft end; a tail section at the aft end; a right wing extending outward from a right side of the fuselage; and a left wing extending outward from a left side of the fuselage. In addition, the hybrid system includes an electric motor-generator-propeller propulsion system having a propeller rotatably connected to the fuselage for pulling or pushing propulsion operation of the hybrid propelled aircraft at least for takeoffs, landing, and ground taxiing, a motor-generator connected to the propeller for driving the propeller for propelling the hybrid propelled aircraft, and one or more electrical storage unit(s) connected to the motor-generator for powering the motor-generator for driving the propeller, wherein the one or more electrical storage unit(s) is configured to absorb and release electrical energy, wherein in a motor mode the motor-generator drives the propeller and in a generator mode charges the one or more electrical storage unit(s). Further, the hybrid propelled aircraft includes at least one wave engine disposed at the aft end of the fuselage for operation of the hybrid propelled aircraft at least in the air after takeoff and before landing.

Disclosed herein is a hybrid propelled aircraft including a fuselage have a nose and aft end; a tail section at the aft end; a right wing extending outward from a right side of the fuselage; and a left wing extending outward from a left side of the fuselage. In addition, the hybrid propelled aircraft includes an electric motor-generator-propeller propulsion system including a propeller rotatably connected to the fuselage for pulling or pushing propulsion operation of the hybrid propelled aircraft at least for takeoffs, landing, and ground taxiing, a motor-generator connected to the propeller for driving the propeller for propelling the hybrid propelled aircraft, and one or more electrical storage unit(s) connected to the motor-generator for powering the motor-generator for driving the propeller, wherein the one or more electrical storage unit(s) is configured to absorb and release electrical energy, wherein in a motor mode the motor-generator drives the propeller and in a generator mode charges the one or more electrical storage unit(s). In addition, the hybrid propelled aircraft includes at least one wave engine disposed at the right wing for operation of the hybrid propelled aircraft at least in the air after takeoff and before landing. Further, the hybrid propelled aircraft includes at least one wave engine disposed at the left wing for operation of the hybrid propelled aircraft at least in the air after takeoff and before landing. In some embodiments, the one or more electrical storage unit(s) can include a rechargeable battery.

These and other embodiments of the present invention will be described in greater detail in the remainder of the Specification referring to the drawings.

### BRIEF DESCRIPTION OF THE DRAWINGS

FIG. 1 shows a representative isometric elevated view of a first embodiment of the present invention.

FIG. 2 shows a representative isometric elevated view of a second embodiment of the present invention.

FIG. 3 shows a representative isometric elevated view of a third embodiment of the present invention.

FIG. 4 shows a representative isometric elevated view of a fourth embodiment of the present invention.

### REFERENCE NUMERALS IN THE DRAWINGS

| | |
|---|---|
| 100 | Aircraft |
| 102 | Electric Motor-Generator-Propeller Propulsion System |
| 104 | One or More Wave Engines |
| 106 | Fuselage |
| 108 | Right Wing |
| 110 | Left Wing |
| 112 | V-Tail |
| 200 | Aircraft |
| 202 | Fuselage |
| 204 | Right Wing |
| 206 | Left Wing |
| 208 | V-Tail |
| 210 | Right Wave Engines |
| 212 | Left Wave Engines |
| 214 | Electric Motor-Generator-Propeller Propulsion System |
| 300 | Aircraft |
| 302 | Fuselage |
| 304 | Right Wing |
| 306 | Left-wing |
| 308 | V-Tail |
| 310/312 | Right Wave Engines |
| 314/316 | Left Wave Engines |
| 318 | Electric Motor-Generator-Propeller Propulsion System |
| 400 | Aircraft |
| 402 | Fuselage |
| 404 | Right Wing |
| 406 | Left-wing |
| 408 | V-Tail |
| 410 | Right Wave Engines |
| 412 | Left Wave Engines |
| 414 | Electric Motor-Generator-Propeller Propulsion System |

### DETAILED DESCRIPTION OF THE INVENTION

In this document, “wave engine”, “pulse combustor”, “pulse jet engine”, “pulse jet”, “pulsejet engine” or “pulsejet” refers to the same device. It is understood that a pulsejet or pulse jet engine is a type of wave engine that may be used for thrust production for aircraft, land craft, and watercraft.

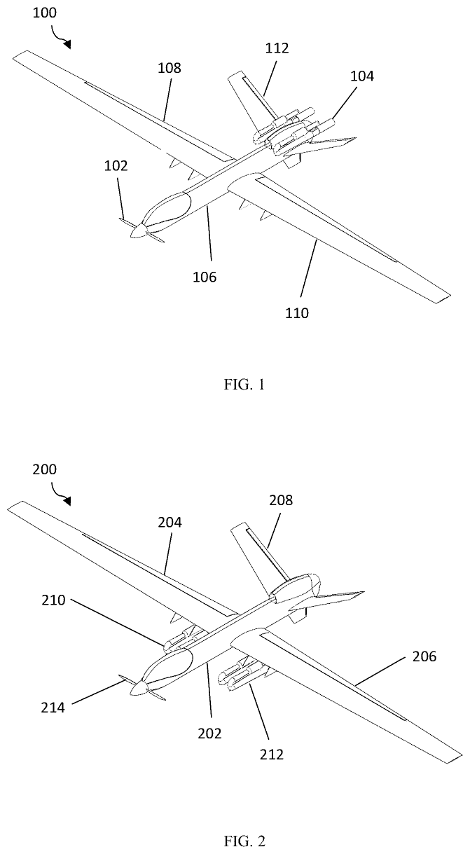

Referring to FIG. 1, it shows an elevated isometric view of a first embodiment of an aircraft of the present invention with a hybrid architecture. Referring to FIG. 1, aircraft 100 has fuselage 106, right wing 108, left wing 110, and V-tail 112. Electric motor-generator-propeller propulsion system 102 is disposed at the front end (e.g., nose end) of fuselage 106. The two wave engines shown at 104 are disposed at the rear (e.g., aft end) of fuselage 106 at the vertex of V-tail 112. The two wave engines may be cross-connected in a way that they are operated in an anti-phase manner to reduce the noise and vibrations created by the engines if operated separately. Such anti-phase operation may be in accordance with co-owned U.S. Pat. No. 11,578,681, the contents of which are incorporated by reference herein, and be within the scope of the present invention. The electric motor-generator-propeller propulsion system 102 has a variable pitch propeller which may include a folding propeller feature to reduce drag in operation when the generator-propeller is not in use for electric power generation or forward thrust, respectively.

With respect to aircraft 100 with a hybrid architecture such as shown in FIG. 1 or any equivalent thereof, for takeoffs, landings, and/or low speed flight operations, it will be mainly propelled by electric motor-generator-propeller propulsion system 102. Propulsion system 102 will produce low noise levels close to the ground and efficient operation at low speeds. When it is desired to operate aircraft 100 at high speed and cruising flight, it will be mainly propelled by the wave engines at 104. Besides the wave engines at 104 enabling high aircraft speeds they also enable the aircraft to travel longer distances. Although FIG. 1 shows two wave engines disposed at the vertex of V-tail 112, it is understood there can be more or less than two wave engines connected to fuselage 106 at the location in FIG. 1 or other locations along the fuselage.

The wave engines at 104 may also be integrated in fuselage 106. In such a configuration, it will be necessary to direct air into the inlet pipe for wave engine operation. This can be accomplished, for example, using ram air supplied according to co-owned U.S. Pat. No. 11,867,138, the contents of which are incorporated by refence herein. The scoop supplying the air may be deployable when the wave engines are in use and retracted when electric motor-generator-propeller propulsion system 102 is propelling the aircraft. When the scoop is deployed to provide forced air to the inlet pipe, portions of it may also be channeled to the motor-generator to turn it to charge the batteries. Further there may be a separate scoop and channeling for providing forced air to the motor-generator at all times for charging the batteries independent of providing forced air to the inlet pipes of the wave engines.

When aircraft 100 is propelled by the wave engines at 104, the propeller of electric motor-generator-propeller propulsion system 102 can be locked, feathered, or folded for drag reduction, or the propeller can be windmilled for turning a motor-generator for electric power production. The electric power produced can be used to charge any batteries on board aircraft 100. Further, these powered batteries can be used to power electric motor-generator-propeller propulsion system 102 during takeoffs, landings, and/or low speed flight. A yet further use of the batteries can be for powering avionics, control surface actuation, and/or fuel supply components. In this manner, operation of aircraft 100 only requires fuel for the wave engines, and the electric power requirements for aircraft 100 can primarily be met by the in-flight operation of electric motor-generator-propeller propulsion system 102. And, to the extent aircraft 100 is on the ground, its electrical power needs may be met by connecting to electrical power outlets.

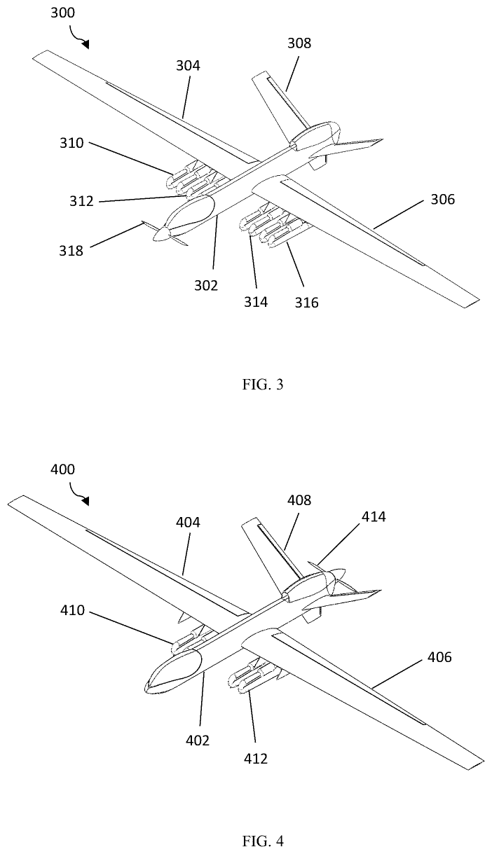

Referring to FIG. 2, it shows an elevated isometric view of a second embodiment of an aircraft of the present invention with a hybrid architecture. In FIG. 2, aircraft 200 has fuselage 202, right wing 204, left wing 206, and V-tail 208. Electric motor-generator-propeller propulsion system 214 is disposed at the front end of fuselage 202. The two wave engines shown at 210 are disposed below right wing 204 and wave engine 212 is disposed below left wing 206. The two wave engines of the pair on each wing may be cross-connected and operated in an anti-phase manner to reduce their noise and vibration. It is understood that wave engines 210 and 212 are disposed with respect to with wings 204 and 206 in a balanced fashion, i.e., each wing would have an equal number of wave jets associated with it as will be shown in FIG. 3. Besides wave engines 210 and 212 being disposed below their respective wings, it is in the scope of the present invention that they may be integrated as part of the wings. With respect to FIG. 2, what was set forth respect to electric motor-generator-propeller propulsion system 102 of the first embodiment, applies equally to electric motor-generator-propeller propulsion system 214 of the second embodiment and, therefore, is incorporated herein by reference.

Referring to FIG. 3, it shows an elevated isometric view of a third embodiment of an aircraft of the present invention with a hybrid architecture. In FIG. 3, aircraft 300 has fuselage 302, right wing 304, left wing 306, and V-tail 308. Electric motor-generator-propeller propulsion system 318 is disposed at the front end of fuselage 302. As shown in FIG. 3, there are two pairs of wave engines attached to the wings of the aircraft. More specifically, right wing 304 has a pair of wave engines at 310 and 312 attached to it; and, similarly, left wing 306 has a pair of engines at 314 and 316 attached to it. With respect to FIG. 3, each of the four pairs of wave engines are operated in an anti-phase manner to reduce the noise and vibration created by the engines if operated separately. The two pairs of wave engines shown at 310 and 312 are disposed below right wing 304 and wave engines 314 and 316 are disposed below left wing 306. The wave engines of each pair may be cross-connected and operated in an anti-phase manner to reduce their noise and vibration. Besides the wave engines being disposed below their respective wings, it is in the scope of the present invention that these wave engines may be integrated as part of the wings. With respect to FIG. 3, what was set forth respect to electric motor-generator-propeller propulsion system 102 of the first embodiment, applies equally to electric motor-generator-propeller propulsion system 318 of the third embodiment and, therefore, is incorporated herein by reference.

Referring to FIG. 4, it shows an elevated isometric view of a fourth embodiment of an aircraft of the present invention with a hybrid architecture. In FIG. 4, aircraft 400 has fuselage 402, right wing 404, left wing 406, and V-tail 408. In the fourth embodiment, the two wave engines at 410 are disposed under right wing 404 and the two wave engines at 412 are disposed under left wing 406. Electric motor-generator-propeller propulsion system 414 in this embodiment is not disposed at the front end of fuselage 402 but in the rear. In this configuration electric motor-generator-propeller propulsion system 414 will push rather than pull the aircraft. Other than this change, the aircraft will operate substantially the same as the aircraft shown and described with respect to the second embodiment in FIG. 2. As such, that description is incorporated here by reference. Although FIGS. 2-4 show one or two pairs of wave engines attached to each wing of the aircraft, it is understood there can be more than two pairs of wave engines connected to each wing at the location in FIGS. 2-4 or other locations along each wing.

The second, third, and fourth embodiment of the hybrid aircraft of the present invention that are shown in FIGS. 2, 3, and 4, respectively, have the added feature of being able to takeoff on shortened runways because both the wave engines and electric motor-generator-propeller propulsion system can be used simultaneously. The first embodiment shown in FIG. 1 can also shorten its takeoff distance when both propulsion methods are enabled, and assuming the wave engines are of the same size, the takeoff distance for the first embodiment will be shortened but not as much as the aircraft shown in the embodiments in FIGS. 2, 3, and 4 because each of these embodiments are being propelled by one or more additional wave engines than are shown in the embodiment in FIG. 1. Once the takeoff is effected, then either of the propulsions systems can be turned off depending on the mission or purpose of the flight.

It is contemplated that systems, devices, methods, and processes of the disclosed invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present disclosure that consist essentially of, or consist of, the recited components, and that there are processes and methods according to the present disclosure that consist essentially of, or consist of, the recited processing steps.

It should be understood that the order of steps or order for performing certain action is immaterial so long as the disclosure remains operable. Moreover, two or more steps or actions may be conducted simultaneously. The mention herein of any publication, for example, in the Background section, is not an admission that the publication serves as prior art with respect to any of the claims presented herein. The Background section is presented for purposes of clarity and is not meant as a description of prior art with respect to any claim.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

Noting the foregoing, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

1. A hybrid propelled aircraft, comprising:
a fuselage having a nose end and an aft end;
a tail section at the aft end;
a right wing extending outward from a right side of the fuselage;
a left wing extending outward from a left side of the fuselage;
an electric motor-generator-propeller propulsion system comprising:
a propeller rotatably connected to the fuselage for pulling or pushing propulsion operation of the hybrid propelled aircraft at least for takeoffs, landing, and ground taxiing,
a motor-generator connected to the propeller for driving the propeller for propelling the hybrid propelled aircraft, and
one or more electrical storage unit(s) connected to the motor-generator for powering the motor-generator for driving the propeller, wherein the one or more electrical storage unit(s) is configured to absorb and release electrical energy, wherein in a motor mode the motor-generator drives the propeller and in a generator mode charges the one or more electrical storage unit(s); and
at least one wave engine disposed at the aft end of the fuselage for operation of the hybrid propelled aircraft at least in the air after takeoff and before landing.

2. The hybrid propelled aircraft as recited in claim 1, wherein the propeller is capable of being folded out of use when the one or more wave engine(s) are being operated.

3. The hybrid propelled aircraft as recited in claim 1, wherein the propeller is capable of being windmilled when not in use to propel the hybrid aircraft to turn the motor-generator to charge the one or more electrical storage unit(s).

4. The hybrid propelled aircraft as recited in claim 1, wherein the electric motor-generator-propeller propulsion system is used for low speed flying operations after takeoff and before landing.

5. The hybrid propelled aircraft as recited in claim 1, wherein at least one wave engine is used for at least high speed flying operations.

6. The hybrid propelled aircraft as recited in claim 1, wherein the propeller is capable of being connected to the nose of the fuselage for pulling operation of the hybrid propelled aircraft.

7. The hybrid propelled aircraft as recited in claim 1, wherein the propeller is capable of being connected to the aft end of the fuselage for pushing operation of the hybrid propelled aircraft.

8. The hybrid propelled aircraft as recited in claim 1, wherein two wave engines are disposed at the aft end of the fuselage and include the two wave engines being cross-connected and operated in anti-phase mode.

9. The hybrid propelled aircraft as recited in claim 1, the at least one wave engine is disposed within the interior of the fuselage.

10. A hybrid propelled aircraft, comprising:
a fuselage have a nose and aft end;
a tail section at the aft end;
a right wing extending outward from a right side of the fuselage;
a left wing extending outward from a left side of the fuselage;
an electric motor-generator-propeller propulsion system comprising:
a propeller rotatably connected to the fuselage for pulling or pushing propulsion operation of the hybrid propelled aircraft at least for takeoffs, landing, and ground taxiing,
a motor-generator connected to the propeller for driving the propeller for propelling the hybrid propelled aircraft, and
one or more electrical storage unit(s) connected to the motor-generator for powering the motor-generator for driving the propeller, wherein the one or more electrical storage unit(s) is configured to absorb and release electrical energy, wherein in a motor mode the motor-generator drives the propeller and in a generator mode charges the one or more electrical storage unit(s);
at least one wave engine disposed at the right wing for operation of the hybrid propelled aircraft at least in the air after takeoff and before landing; and
at least one wave engine disposed at the left wing for operation of the hybrid propelled aircraft at least in the air after takeoff and before landing.

11. The hybrid propelled aircraft as recited in claim 10, wherein the propeller is capable of being folded out of use when the one or more wave engine(s) are being operated.

12. The hybrid propelled aircraft as recited in claim 10, wherein the propeller is capable of being windmilled when not in use to propel the hybrid propelled aircraft to turn the motor-generator to charge the one or more electrical storage unit(s).

13. The hybrid propelled aircraft as recited in claim 10, wherein the electric motor-generator-propeller propulsion system is used for low speed flying operations after takeoff and before landing.

14. The hybrid propelled aircraft as recited in claim 10, wherein at least one wave engine at the right wing and left wing are used for at least high speed flying operations.

15. The hybrid propelled aircraft as recited in claim 10, wherein the propeller is capable of being connected to the nose of the fuselage for pulling operation of the hybrid propelled aircraft.

16. The hybrid propelled aircraft as recited in claim 10, wherein the propeller is capable of being connected to the aft end of the fuselage for pushing operation of the hybrid propelled aircraft.

17. The hybrid propelled aircraft as recited in claim 1, wherein two wave engines are disposed at the aft end of the fuselage and include the two wave engines being cross-connected to operate in anti-phase mode.

18. The hybrid propelled aircraft as recited in claim 1, wherein an air scoop is disposed along the fuselage for channeling ram air to the motor generator for turning the generator to charge the one or more storage unit(s).

19. The hybrid propelled aircraft as recited in claim 10, wherein an air scoop is disposed along the fuselage for channeling ram air to the motor generator for turning the generator to charge the one or more storage unit(s).

20. The hybrid propelled aircraft as recited in claim 9, wherein an air scoop is disposed along the fuselage for channeling ram air to an inlet pipe of one or more wave engines for mixing with fuel for carrying out combustion cycles of the one or more wave engines and/or to the motor generator for turning the generator to charge the one or more storage unit(s).
